(19) United States
(12) Patent Application Publication
(10) Pub. No.: US 2011/0078955 A1
(43) Pub. Date: Apr. 7, 2011

(54) LOUVER BLADE INCLUDING A REINFORCING PLATE

(76) Inventor: Tai-Long Huang, Changhua County (TW)

(21) Appl. No.: 12/574,823

(22) Filed: Oct. 7, 2009

(51) Int. Cl. E06B 7/08

(52) U.S. Cl. 49/92.1

(57) ABSTRACT

A louver blade for a louvered window includes: a longitudinal blade body having opposite first and second surfaces that extend along a longitudinal axis of the blade body, two transverse surfaces that extend along a first transverse axis perpendicular to the longitudinal axis, and two pivot holes formed respectively in the transverse surfaces and aligned with the longitudinal axis; and a longitudinal reinforcing plate disposed within the blade body. The reinforcing plate includes an intermediate bent portion, and two end portions extending from the intermediate bent portion. The reinforcing plate has a minimum distance from the longitudinal axis, which is larger than the radii of the pivot holes.

### BACKGROUND OF THE INVENTION

1. Field of the Invention

This invention relates to a louver blade, more particularly to a louver blade including a reinforcing plate.

2. Description of the Related Art

Referring to FIG. 1, a conventional louver blade 2 is a single-piece article made from polyvinyl chloride (PVC). The louver blade 2 includes two spaced-apart end surfaces 21 and a surrounding wall 22 interconnecting the two end surfaces 21. The louver blade 2 is pivotally secured to a jamb of a louvered window and is operable to adjust vent holes of the louvered window. However, since the structural strength of the louver blade 2 is poor, the louver blade 2 tends to sag and deform at its middle section when the louver blade 2 is used for a long period of time or when the louver blade 2 is lengthened. The louver blade 2 which is deformed can result in an unsatisfactory air sealing effect when the louvered window is closed, or can easily rub against the jamb during a louver operation, thereby adversely affecting the smoothness of the louver operation.

Referring to FIG. 2, a solution to the aforesaid insufficient strength problem is to provide a louver blade 3 that includes a metal support member 31 embedded within a blade body 32 made from polyvinyl chloride, and two mounting holes 311 formed in the support member 31 for extension of two pivot studs 301 mounted on a window frame 30. By embedding the support member 31 in the blade body 32, the structural strength of the louver blade 3 is improved. However, since the mounting holes 311 must be centered with respect to the blade body 32, there is a need for centering the support member 31 with the blade body 32. Such need is time-consuming during manufacture. In addition, when the support member 31 is not centered with the blade body 32, the mounting holes 311 will deviate from the center of the blade body 32, and will be unable to be aligned with the pivot studs 301, thereby becoming a defective product or waste.

### SUMMARY OF THE INVENTION

Therefore, an object of the present invention is to provide a louver blade that can overcome the aforesaid drawbacks associated with the prior art.

According to the present invention, a louver blade for a louvered window comprises: a longitudinal blade body having opposite first and second surfaces that extend along a longitudinal axis of the blade body and that are symmetrical with respect to the longitudinal axis, two transverse surfaces that extend along a first transverse axis perpendicular to the longitudinal axis and that interconnect the first and second surfaces, and two pivot holes formed respectively in the transverse surfaces and aligned with the longitudinal axis; and a longitudinal reinforcing plate disposed within the blade body, and spaced apart from the longitudinal axis. The reinforcing plate includes an intermediate bent portion that is proximate to the first surface and that extends along the longitudinal axis, and two end portions extending from the intermediate bent portion toward the second surface. The reinforcing plate has a minimum distance from the longitudinal axis, which is larger than the radii of the pivot holes.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of a conventional louver blade;

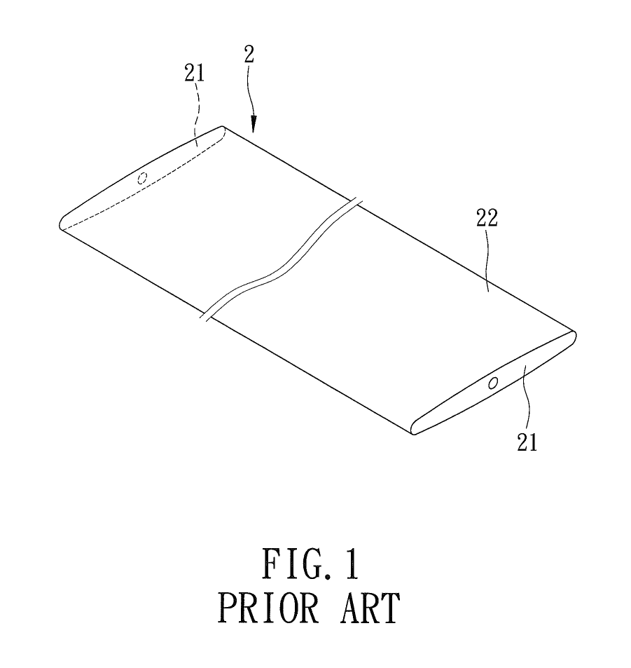

FIG. 2 is a partly exploded perspective view of a conventional louvered window;

FIG. 3 is a perspective view of the preferred embodiment of a louver blade according to this invention;

FIG. 4 is a side view of the preferred embodiment illustrating a reinforcing plate symmetrical relative to an axis; and

FIG. 5 is a side view of the preferred embodiment illustrating the reinforcing plate asymmetrical relative to the axis.

### DETAILED DESCRIPTION OF THE PREFERRED EMBODIMENT

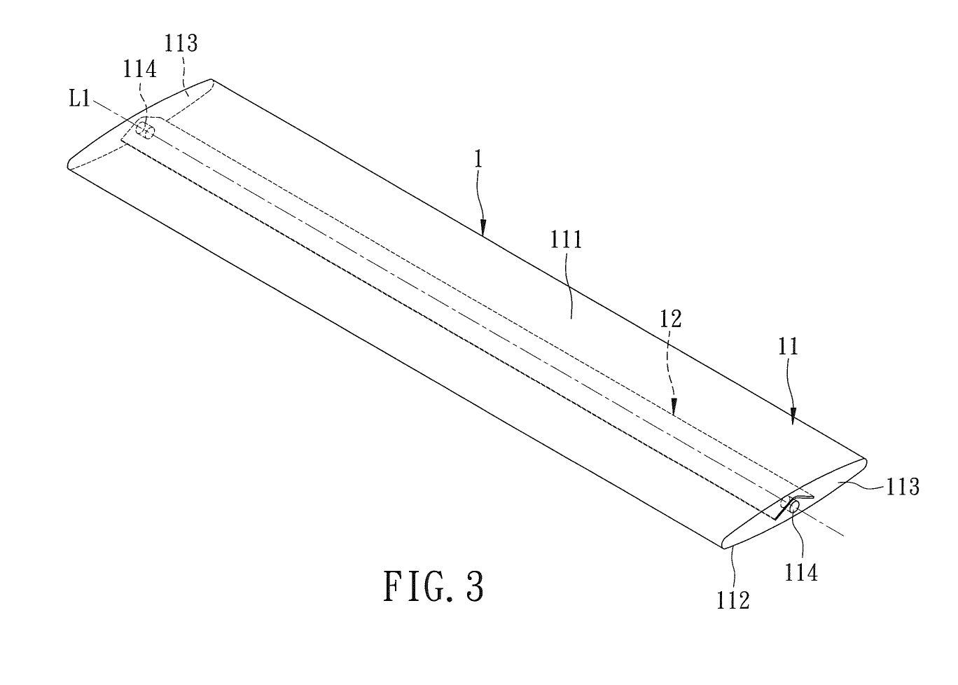

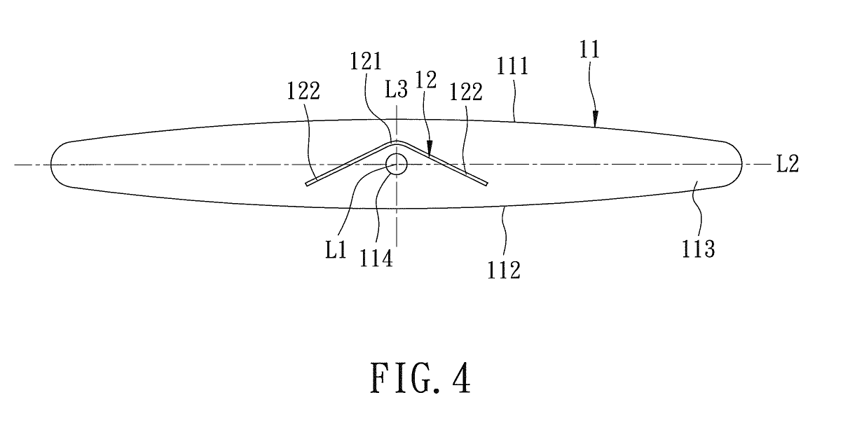

FIGS. 3 and 4 illustrate a louver blade 1 of a preferred embodiment according to this invention. The louver blade 1 is adapted for application to a louvered window and includes a longitudinal blade body 11 and a longitudinal reinforcing plate 12.

The longitudinal blade body 11 is made from polyvinyl chloride and encloses the longitudinal reinforcing plate 12. The longitudinal blade body 11 has opposite first and second surfaces 111, 112 that extend along a longitudinal axis (L1) of the blade body 11 and that are symmetrical with respect to the longitudinal axis (L1), two transverse surfaces 113 that extend along a first transverse axis (L2) perpendicular to the longitudinal axis (L1) and that interconnect the first and second surfaces 111, 112, and two pivot holes 114 formed respectively in the transverse surfaces 113 and aligned with the longitudinal axis (L1). It is worth mentioning that the two pivot holes 114 are formed by drilling in the transverse surfaces 113 after formation of the longitudinal blade body 11 and the reinforcing plate 12.

The longitudinal reinforcing plate 12 is made of a metal, such as aluminum or iron. In this embodiment, the longitudinal reinforcing plate 12 is made of aluminum and is symmetrical relative to a second transverse axis (L3) perpendicular to the longitudinal and first transverse axes (L1, L2). The longitudinal reinforcing plate 12 is disposed within the blade body 11, and is spaced apart from the longitudinal axis (L1) . The longitudinal reinforcing plate 12 includes an intermediate bent portion 121 that is proximate to the first surface 111 and that extends along the longitudinal axis (L1), and two end portions 122 divergingly extending from the intermediate bent portion 121 toward the second surface 112. The two end portions 122 are planar and extend on two sides of the longitudinal axis (L1). The longitudinal reinforcing plate 12 has a minimum distance from the longitudinal axis (L1), which is larger than the radii of the pivot holes 114.

Preferably, the longitudinal reinforcing plate 12 has a V-shaped cross-section. Alternatively, the cross-section of the longitudinal reinforcing plate 12 can be provided with a U-shape or other bent shapes.

The louver blade 1 is made by first heating and bending a metal strip to form the reinforcing plate 12 and placing the same in a mold. Subsequently, melted polyvinyl chloride material is injected into the mold and is molded over the longitudinal reinforcing plate 12 to form the blade body 11. After cooling for a predetermined time, the molded blade body 11 having the longitudinal reinforcing plate 12 therein is cut to a predetermined length and is drilled to form the two pivot holes 114 with a predetermined radius in the two transverse surfaces 113, thereby forming the louver blade 1.

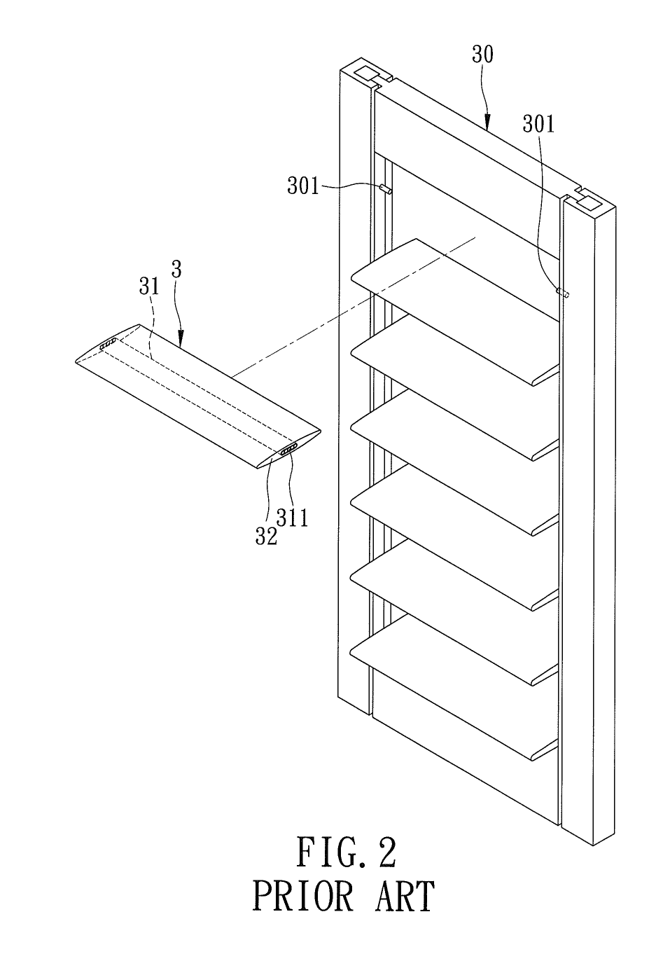

By virtue of the simple shape of the longitudinal reinforcing plate 12, material required for making the longitudinal reinforcing plate 12 can be reduced. Furthermore, due to the angled beam design of the longitudinal reinforcing plate 12 which can provide increased flexural strength, the structural strength of the longitudinal reinforcing plate 12 is improved compared to the support member 31 shown in FIG. 2.

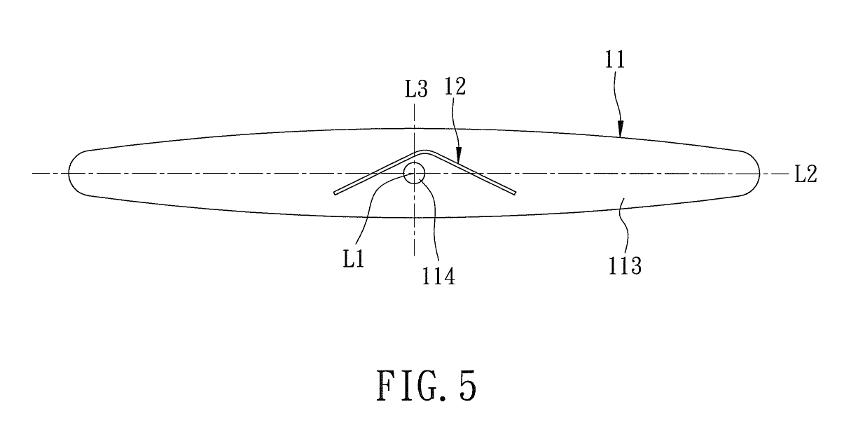

In addition, during the process of making the blade body 11 and the longitudinal reinforcing plate 12, it is not necessary to center the longitudinal reinforcing plate 12 with respect to the blade body 11, thereby simplifying the process. Since the pivot holes 114 are not formed in the longitudinal reinforcing plate 12, even when the reinforcing plate 12 is asymmetrical with respect to the longitudinal axis (L1) and the second transverse axis (L3) of the blade body 11, the pivot holes 114 can be still aligned with the longitudinal axis (L1), or centered with respect to the blade body 11, as shown in FIG. 5. Therefore, the problem of waste produced by defective products due to misalignment can be alleviated.

With the invention thus explained, it is apparent that various modifications and variations can be made without departing from the spirit of the present invention. It is therefore intended that the invention be limited only as recited in the appended claims.

What is claimed is:

1. A louver blade for a louvered window comprising:
a longitudinal blade body having opposite first and second surfaces that extend along a longitudinal axis of said blade body and that are symmetrical with respect to said longitudinal axis, two transverse surfaces that extend along a first transverse axis perpendicular to said longitudinal axis and that interconnect said first and second surfaces, and two pivot holes formed respectively in said transverse surfaces and aligned with said longitudinal axis; and
a longitudinal reinforcing plate disposed within said blade body, and spaced apart from said longitudinal axis, said reinforcing plate including an intermediate bent portion that is proximate to said first surface and that extends along said longitudinal axis, and two end portions extending from said intermediate bent portion toward said second surface, said reinforcing plate having a minimum distance from said longitudinal axis, which is larger than the radii of said pivot holes.

2. The louver blade of claim 1, wherein said reinforcing plate has a V-shaped cross-section.

3. The louver blade of claim 2, wherein said end portions are planar and extend divergingly from said intermediate bent portion toward said second surface.

4. The louver blade of claim 1, wherein said reinforcing plate is symmetrical relative to a second transverse axis perpendicular to said longitudinal and first transverse axes.

5. The louver blade of claim 1, wherein said reinforcing plate is made from aluminum or iron.
